(19) United States
(12) Patent Application Publication
(10) Pub. No.: US 2025/0384048 A1
(43) Pub. Date: Dec. 18, 2025

(54) METHOD FOR CREATING LICENSE INFORMATION BASE AND ELECTRONIC DEVICE

(71) Applicant: Beijing Youzhuju Network Technology Co., Ltd., Beijing (CN)

(72) Inventors: Yanqing LI, Beijing (CN); Jifeng LI, Beijing (CN); Jian WANG, Beijing (CN)

(21) Appl. No.: 18/879,704

(22) PCT Filed: Sep. 20, 2023
(86) PCT No.: PCT/CN2023/120185

§ 371 Date: Dec. 27, 2024

(30) Foreign Application Priority Data
Sep. 27, 2022 (CN) 202211185311.0

(51) Int. Cl. G06F 16/2457; G06F 30/31

(52) U.S. Cl. CPC G06F 16/24575; G06F 30/31

(57) ABSTRACT

Embodiments of the present disclosure relate to a method and apparatus for creating a license information base, an electronic device, a computer-readable storage medium, and a computer program product. The method includes sending a license query request to a license management module, wherein the license query request is used for obtaining license information on at least one license server. The method includes receiving the license information from the license management module, wherein the license information is retrieved by the license management module from the at least one license server. The method further includes creating a license information base based on the received license information. In this way, license information from one or more license servers is obtained through the license management module, and related license information is integrated, to create a more comprehensive information base for subsequent processing.

### CROSS-REFERENCE TO RELATED APPLICATION(S)

The present application claims the priority of Chinese Patent Application No. 202211185311.0, filed on Sep. 27, 2022, the entire teachings of which are incorporated herein by reference.

### FIELD

Embodiments of the present disclosure generally relate to the field of computer software, and more particularly, to a method and apparatus for creating a license information base, an electronic device, a computer-readable storage medium, and a computer program product.

### BACKGROUND

A software license is a right between a software provider and the user used to define and limit a user to use software. For example, electronic design automation (EDA) refers to a design method of completing a process such as functional design, synthesis, verification, and physical design of an ultra-large-scale integrated circuit chip by using a computer-aided design software. An EDA designer may design on an EDA software platform by using a hardware description language, and then perform logical compilation, optimization, routing, simulation, and the like by using a computer.

Costs of EDA tools account for a relatively high ratio of total costs of integrated circuit design, and a price of a full-process EDA tool is very high. For efficient utilization and cost saving, it is necessary to learn about a license usage of each feature of EDA software. Therefore, retrieval of license information of EDA software has practical importance for cost reduction and efficiency improvement in integrated circuit chip design.

### SUMMARY

According to an example embodiment of the present disclosure, a mechanism for creating a license information base is provided. License information from one or more license servers is obtained through a license management module, and related license information is integrated, to create a more comprehensive information base for subsequent processing.

In a first aspect of the present disclosure, a method for creating a license information base is provided. The method includes sending a license query request to a license management module, wherein the license query request is used for obtaining license information on at least one license server. The method further includes receiving the license information from the license management module, wherein the license information is retrieved by the license management module from the at least one license server. The method further includes creating the license information base based on the received license information.

In a second aspect of the present disclosure, an electronic device is provided. The electronic device includes at least one processing unit and at least one memory. The at least one memory is coupled to the at least one processing unit and stores instructions executable by the at least one processing unit, and the instructions, when executed by the at least one processing unit, cause the electronic device to perform actions. The actions include sending a license query request to a license management module, wherein the license query request is used for obtaining license information on at least one license server. The action further includes receiving the license information from the license management module, wherein the license information is retrieved by the license management module from the at least one license server. The action further includes creating the license information base based on the received license information.

In a third aspect of the present disclosure, an apparatus for creating a license information base is provided. The apparatus includes a query request sending module, configured to send a license query request to a license management module, wherein the license query request is used for obtaining license information on one or more license servers. The apparatus further includes an information receiving module, configured to receive the license information from the license management module, wherein the license information is retrieved by the license management module from the one or more license servers. The apparatus further includes an information base creation module, configured to create the license information base based on the received license information.

In a fourth aspect of the present disclosure, a computer-readable storage medium having machine-executable instructions stored thereon is provided. The machine-executable instructions, when executed by a device, cause the device to perform the method described in the first aspect of the present disclosure.

In a fifth aspect of the present disclosure, a computer program product including computer-executable instructions is provided, wherein the computer-executable instructions, when executed by a processor, implement the method described in the first aspect of the present disclosure.

In a sixth aspect of the present disclosure, an electronic device is provided. The electronic device includes a processing circuit configured to perform the method described in the first aspect of the present disclosure.

This Summary is provided to introduce a selection of concepts in a simplified form that are further described below in the Detailed Description. This Summary is not intended to identify key features or essential features of the present disclosure, nor is it intended to be used to limit the scope of the present disclosure. Other features of the present disclosure will be readily understood through the following description.

### BRIEF DESCRIPTION OF THE DRAWINGS

The above and other features, advantages, and aspects of embodiments of the present disclosure will become more apparent with reference to the following detailed description in conjunction with the accompanying drawings. In the drawings, the same or similar reference signs denote the same or similar elements, where:

FIG. 1 shows a schematic diagram of an example environment in which embodiments of the present disclosure can be implemented;

FIG. 2 shows a flowchart of an example method of creating a license information base according to some embodiments of the present disclosure;

FIG. 3 shows a flowchart of an example method of extracting an information item according to some embodiments of the present disclosure;

FIGS. 4A-4F show example diagrams of license information and information items according to some embodiments of the present disclosure;

FIG. 5 shows a flowchart of an example method of searching for an information item according to some embodiments of the present disclosure;

FIGS. 6A-6D show schematic diagrams of search interfaces according to some embodiments of the present disclosure;

FIG. 7 shows a block diagram of an example apparatus according to an embodiment of the present disclosure; and

FIG. 8 shows a block diagram of an example device that can be used to implement an embodiment of the present disclosure.

### DETAILED DESCRIPTION OF EMBODIMENTS

Embodiments of the present disclosure are described in more detail below with reference to the accompanying drawings. Although some embodiments of the present disclosure are shown in the drawings, it would be appreciated that the present disclosure may be implemented in various forms and should not be construed as being limited to the embodiments set forth herein. Rather, these embodiments are provided for a more thorough and complete understanding of the present disclosure. It would be appreciated that the accompanying drawings and embodiments of the present disclosure are only for illustrative purposes, and are not intended to limit the scope of protection of the present disclosure.

As described above, many software (for example, EDA software) requires a license file for use. The license file usually maintains the usage of the EDA software, and usage information of the EDA software can be obtained by monitoring the license file.

Conventionally, a user needs to obtain permission before accessing a license file on a license server to monitor related usage information. However, there are usually a plurality of clients deployed on the user side, and not all clients have permission to access the license server. Therefore, many users cannot obtain license usage information immediately. In addition, access to a server of the license file is usually separate, and the user may need to use different features of different EDA software. Separate access cannot provide comprehensive usage information.

To at least partially solve the defects in the foregoing technical solution, an embodiment of the present disclosure provides a solution that can obtain license information from one or more servers through a license management module and use the license management module as an interface with a license server, to provide comprehensive and up-to-date license-related information. It would be appreciated that although EDA software is used as an example in some embodiments of the present disclosure, the embodiments of the present disclosure are not limited to EDA software.

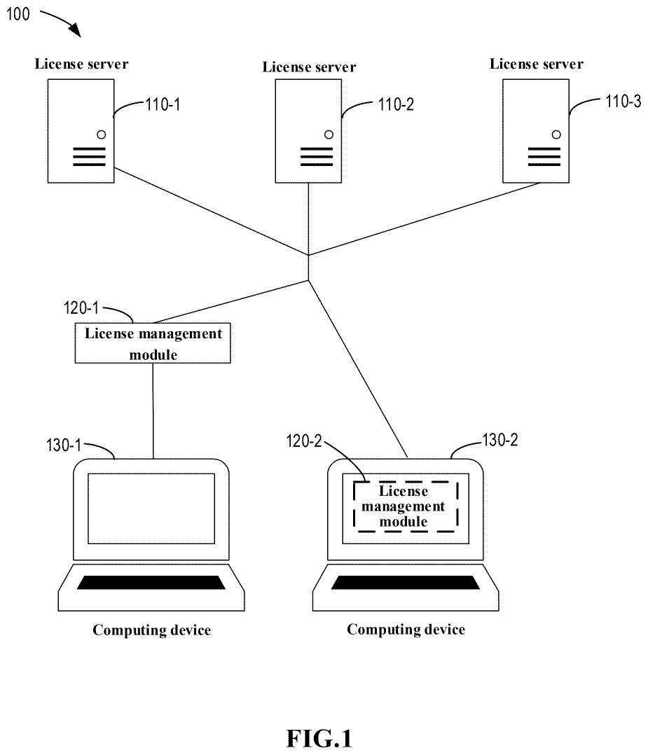

FIG. 1 shows a schematic diagram of an example environment 100 in which embodiments of the present disclosure can be implemented. As shown in FIG. 1, the example environment 100 includes a plurality of license servers 110-1, 110-2, and 110-3 (collectively referred to as license servers 110), a plurality of license management modules 120-1 and 120-2 (collectively referred to as license management modules 120), and a plurality of computing devices 130-1 and 130-2 (collectively referred to as computing devices 130). Each license server 110 may maintain a license of one or more EDA software. The computing devices 130 are connected to the license servers 110 through the license management modules 120. The computing devices 130 may send a request for license information to the license management modules 120. After receiving the request, the license management modules 120 may access the license servers and retrieve related information, and then feed the information back to the computing devices 130. In some embodiments, the license management modules 120 may be set as devices independent of the computing devices 130, for example, the license management module 120-1 is independent of the computing device 130-1. The license management modules 120 may also be deployed on the computing devices 130, for example, the license management module 120-2 is deployed on the computing device 130-2.

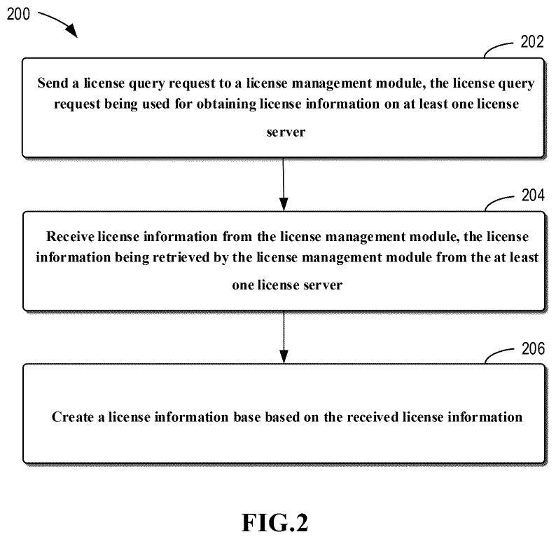

For example, when the computing device 130-2 sends a query request for license information to the license management module 120-2, the license management module 120-2 may process the received query request to determine a license server 110 on which the queried information is located. After determining that the queried information is located on the license servers 110-1 and 110-2, the license management module 120-2 accesses or communicates with the license servers 110-1 and 110-2 to obtain corresponding information. An example solution of creating an information base by using the obtained license information and searching for an information item by using the information base is described in detail below with reference to FIGS. 2 to 6D.

FIG. 2 shows a flowchart of an example method 200 of creating a license information base according to some embodiments of the present disclosure. The method 200 may be implemented, for example, by the computing device 130 in FIG. 1 or another computing device.

At 202, the computing device 130 sends a license query request to a license management module. The license query request is used for obtaining license information on at least one license server 110. The recept of the license query request causes the license management module 120 to retrieve the queried information from the at least one license server 110 in a corresponding manner. In some embodiments, the license query request may be a query request for all licenses for which a user has obtained a right to use. In this way, all information can be obtained to make subsequent processing more comprehensive.

At 204, the computing device 130 receives the license information from the license management module, wherein the license information is retrieved by the license management module from the at least one license server. The license management module 120 may access or communicate with, for example, at least one license server including a license for which the right to use has been obtained. After receiving the query request, the license management module may, for example, determine a license server for the response information and retrieve the response information.

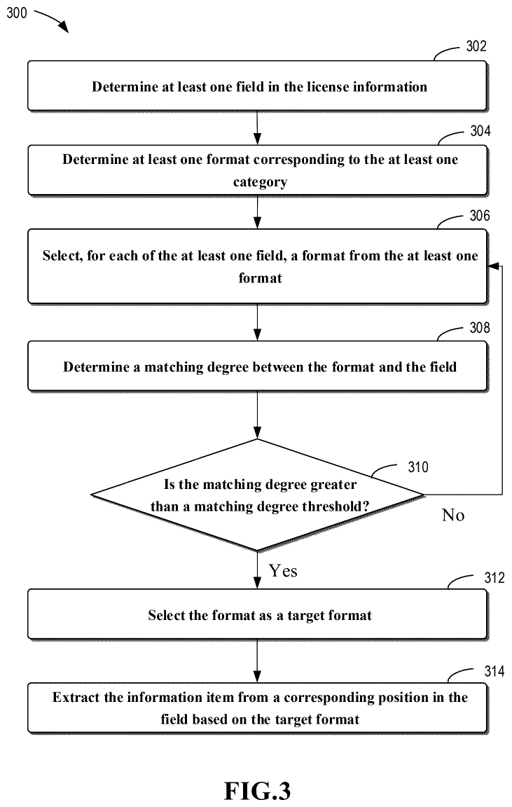

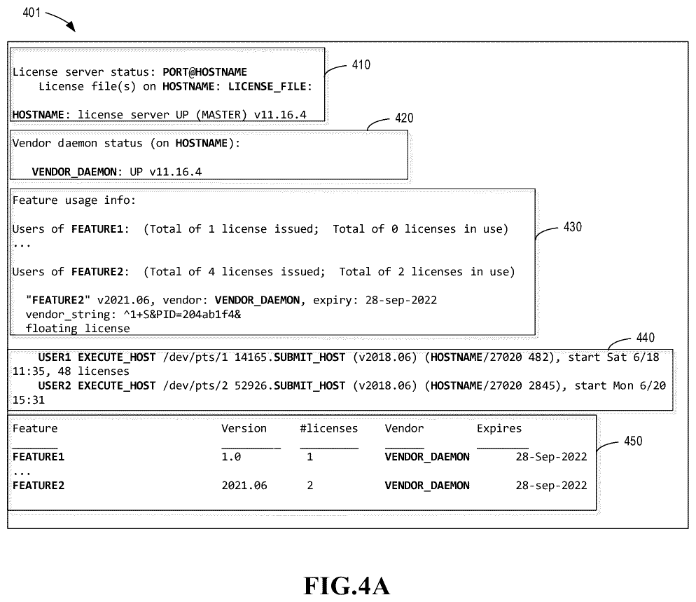

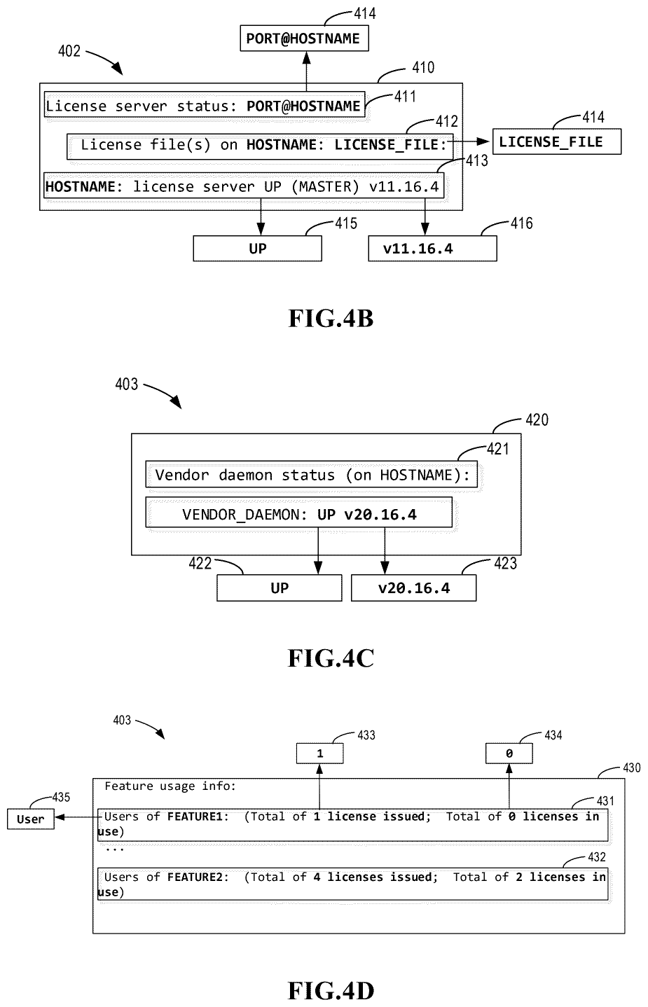

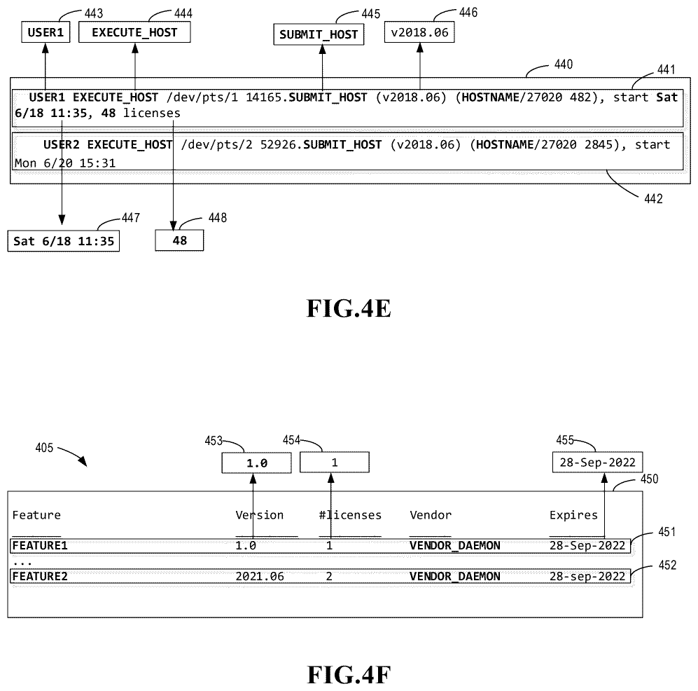

At 206, the computing device 130 creates the license information base based on the received license information. After receiving the license information, the computing device 130 may store the license information in a certain format, and create the license information base based thereon. In some embodiments, the computing device 130 may extract the queried information from the license information, and integrate the information to create the license information base. For example, the computing device 130 may extract a state of a license server, a state of a daemon, a total number of software features, an expiration of a software feature, a number of software features that are being used, a user who is using a software feature, and a usage time of a software feature that is being used for a plurality of EDA software features. A method of extracting information is described in detail below with reference to FIG. 3 and FIG. 4A-4F.

In this way, license information of a license server is obtained through the license management module, so that the required license information can be obtained without directly accessing a license file on the license server after being authorized, and a license information base can be stored and created based on the license information for further retrieval.

FIG. 3 shows a flowchart of an example method 300 of extracting an information item according to some embodiments of the present disclosure. The method 300 may be implemented, for example, by the computing device 130 in FIG. 1 or another computing device.

After the license information is obtained, at 302, the computing device 130 determines at least one field in the license information. The obtained license information usually includes a plurality of fields. Each field may include one or more information items. Information items in one field are all associated with a category of the field. For example, in a field belonging to a license server category, information items about information such as a name and a state of a license server may be included.

At 304, the computing device 130 determines at least one format corresponding to the at least one category. The license information obtained from the license management module has a unified overall format, and fields included in the license information each have a fixed format corresponding to a category of the field. In some embodiments, the overall format may indicate a relative position of each field in the license information, and the format of the field may indicate a position of a corresponding information item in the field.

At 306, for each of the at least one field, the computing device 130 selects one format from the at least one format. After determining the category of the field included in the license information and the corresponding format, the computing device 130 extracts a required information item from the license information field by field. In some embodiments, one field may be one row in the license information. In this case, the computing device 130 may extract the information item from the license information row by row. In some embodiments, the format may be selected based on a specific rule. In an alternative embodiment, the format may be randomly selected.

At 308, the computing device 130 determines a first matching degree between the selected format and the field, and at 310, determines whether the first matching degree is greater than a predetermined matching degree threshold. If the computing device 130 determines that the first matching degree is greater than the predetermined matching degree threshold, at 312, the computing device 130 selects the format as a target format. If the computing device 130 determines that the first matching degree is not greater than the predetermined matching degree threshold, the method 200 returns to 306. At 306, the computing device 130 selects one format from other formats for matching, until the matching degree of the selected format is greater than the predetermined matching degree threshold.

Generally, a ratio of a field of each category in all fields in the license information is different. Therefore, the computing device 130 may determine a priority of a format corresponding to each category based on a ratio of a field of each category in the license information, and then select, from the at least one format, a format with a highest priority as a first format. Thereafter, for example, information about a daemon has a relatively low ratio, and information items related to a software feature have a relatively high ratio. Therefore, the computing device 130 first selects a format corresponding to the information items related to the software feature to start extracting the information items. In some embodiments, a “space” in the license information items may be considered as an information item with no information, and the ratio of the space is usually the highest. In this way, by considering that different categories of license information occur at different frequencies, and determining a priority during format matching based on this, a speed of information extraction can be greatly accelerated.

After the target format is determined, at 314, the computing device 130 extracts the information item from a corresponding position in the field based on the target format. In this way, through multi-format matching, a format that matches the field the most is selected for parsing, so that an expected information item can be accurately extracted, and the created information base can be more accurate. An information extraction process according to the present disclosure is described in detail below with reference to FIGS. 4A to 4F.

FIG. 4A-4F show schematic diagrams of example license information and an information item extraction process according to some embodiments of the present disclosure. FIG. 4A shows a schematic diagram of example license information 401 according to some embodiments of the present disclosure. As shown in FIG. 4A, the license information 401 is, for example, received from the license management module 120 by using the foregoing method. The license information 401 includes a server field 410, a daemon field 420, a software feature field 430, a user field 440, and a license expiration field 450.

It should be understood that the license information 401 in FIG. 4A may be only a part of the obtained information, and may further include another field. The present disclosure is not intended to be limited thereto. Example processes of extracting information items of respective categories are separately described below with reference to FIGS. 4B to 4F.

FIG. 4B shows a schematic diagram of an example process 402 of extracting an information item about a license server. The server field 410 indicates a related information item about a server that starts an EDA license authorization software feature, for example, a server name and a server state. As shown in FIG. 4B, the server field 410 includes a first sub-field 411. The first sub-field 411 includes an information item about a server name and a port. For example, a server name and port information item 414 may be obtained through the following regular matching:
License server status: license_server,
   where the server name is HOSTNAME and the port is PORT.

The server field 410 further includes a second sub-field 412. The second sub-field 412 includes an information item about a path of a license file. For example, a license file information item 415 may be obtained through the following regular matching:

$$License file ( s ) on ∖ S + \text{:} liense\_file ,$$

where the license file information item 415 is an address LICENSE FILE.

The server field 410 further includes a third sub-field 413. The third sub-field 413 includes an information item about a server state and a version. For example, a server state information item 415 and a version information item 416 may be obtained through the following regular matching:

$$license server license\_server \_status ( ∖ S + ) license\_server \_version ,$$

where the server state information item 415 is “UP”, indicating that the server is online, and the version information item 416 is v11.16.4.

FIG. 4C shows a schematic diagram of an example process 403 of extracting an information item about a daemon. The daemon field 420 indicates an information item about a license service daemon (also referred to as a vendor daemon) that is started on a license server. Generally, each daemon corresponds to a unique license server. As shown in FIG. 4C, the daemon field 420 includes a first sub-field 421. The first sub-field 421 includes an information item about a daemon state and a version. For example, a daemon state information item 422 and a daemon state version information item 423 may be obtained through the following regular matching:
vendor_daemon: vendor_daemon_status vendor_daemon_version,
   where the daemon state information item 422 is “UP”, indicating that the daemon is online, and the daemon state version information item 423 is v20.16.4.

FIG. 4D shows a schematic diagram of an example process 404 of extracting an information item about a number of software features. The software feature field 430 indicates a total number of features in EDA software and a current usage. As shown in FIG. 4D, the software feature field 430 includes a first sub-field 431. The first sub-field 431 includes an information item about a user, a total number, and a current usage of a software feature 1. For example, a user information item 433, a total number information item 433, a current usage information item 434, and a user information item (user) 435 may be obtained through the following regular matching:
Users of feature: (Total of issued license issued;
   Total of in_use license in use),
      where the user of the software feature 1 is User, the total number is 1, and the current usage is 0.

The software feature field 430 further includes a second sub-field 432. The second sub-field 432 includes an information item about a user, a total number, and a current usage of a software feature 2. Since an information item extraction process for the second sub-field 432 is similar to an extraction process for the first sub-field 431, details are not described herein again.

FIG. 4E shows a schematic diagram of an example process 405 of extracting an information item about a user of a software feature. The user field 440 indicates a usage of a software feature of the EDA software, for example, a current user of one software feature, a number of uses, and a start time. As shown in FIG. 4E, the software feature field 440 includes a first sub-field 441. The first sub-field 441 includes an information item about a user 1 who is using the software feature. For example, a user information item 443, a computing device information item 444 that is using the software feature, a computing device information item 445 that delivers an EDA tool, a version information item 446, a start time information item 447, and a number of occupied information items 448 may be obtained through the following regular matching:

$$user execute\_host ∖ S + ∖ d + ∖ . submit\_host ( version ) ( ∖ S + ( ∖ d + ) ? ) , start ( start\_time ) ( , license\_num licenses ) ,$$

where the user is USER1, the device that is using the software feature is EXECUTE_HOST, the device that delivers the EDA tool is SUBMIT_HOST, the version is v2018.06, the start time is Saturday, June 18, at 11:35, and the number of occupied is 48. In addition, the software feature field 440 further includes a second sub-field 442. The second sub-field 442 includes an information item about a user 2 who is using the software feature. Since an information item extraction process for the second sub-field 442 is similar to an extraction process for the first sub-field 441, details are not described herein again.

FIG. 4F shows a schematic diagram of an example process 406 of extracting an information item about a license server. The license expiration field 450 indicates an information item about an expiration of a license of each software feature. As shown in FIG. 4F, the license expiration field 450 includes a first sub-field 451. The first sub-field 451 includes an information item about an expiration of a license of the software feature 1. For example, a version information item 453, a number information item 454, and an expiration date information item 455 may be obtained through the following regular matching:
FEATURE version license VENDOR_DAEMON expires,
   where the version of the software feature 1 is 1.0, the number is 1, and the expiration date is Sep. 22, 2022. In addition, the license expiration field 450 further includes a second sub-field 452. The second sub-field 452 includes an information item about an expiration of a license of the software feature 2. Since an information item extraction process for the second sub-field 452 is similar to an extraction process for the first sub-field 451, details are not described herein again.

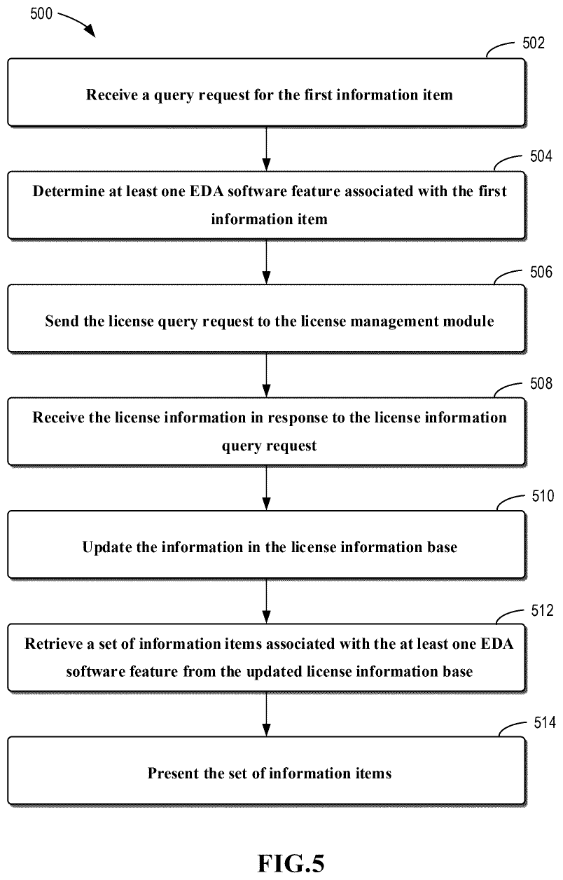

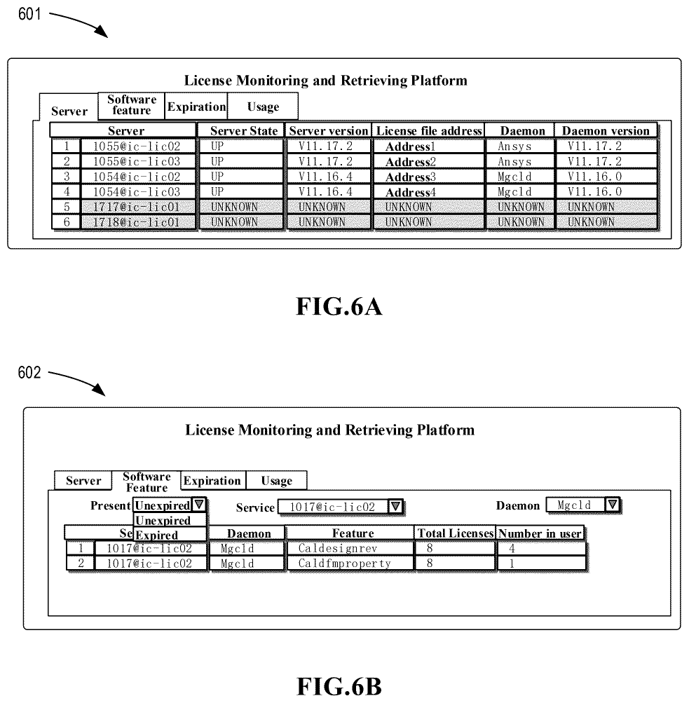

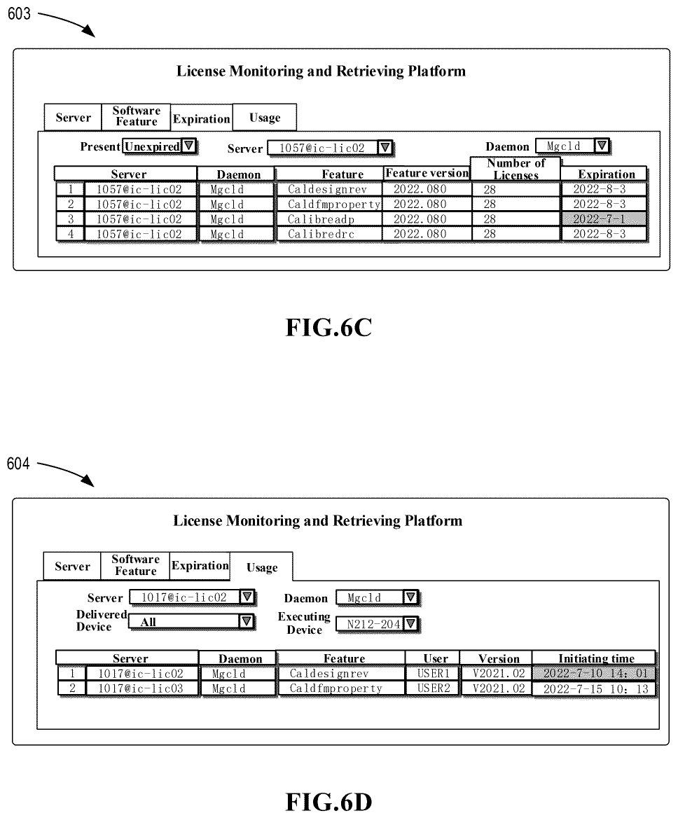

In such an embodiment, based on understanding of an overall format of the license information segment obtained from the license management module and a format of a field included in the license information segment, a corresponding regular expression can be determined for field-by-field parsing. In this way, the queried information item can be accurately obtained. A process of searching for an information item in the created license information base is described below with reference to FIG. 5 to FIG. 6D.

FIG. 5 shows a flowchart of an example method 500 of retrieving an information item according to some embodiments of the present disclosure. The method 500 may be implemented, for example, by the computing device 130 in FIG. 1 or another computing device. As shown in FIG. 5, at 502, the computing device 130 receives a query request for an information item in the license information base. The information item may be any one of the information items described in FIG. 4A to FIG. 4F.

At 504, the computing device 130 determines at least one EDA software feature associated with the queried information item. The information items in the information base may be, for example, organized using the EDA software features as indexes. Information items associated with each EDA software feature may include information items of all the categories shown in the embodiments of FIG. 4A to FIG. 4F. Therefore, each information item is associated with at least one EDA software feature.

While receiving the query request for the information item, at 506, the computing device 130 sends a license query request to the license management module to obtain current license information. At 508, the computing device 130 receives current license information in response to the license information query request. At 510, the computing device 130 updates information in the license information base by using the current license information.

At 512, the computing device 130 retrieves a set of information items associated with the at least one EDA software feature from the updated license information base. The set of information items may be information items of all categories for each EDA software feature in the at least one EDA software feature. The set of information items may also be information items that belong to a same category as the information item indicated by the query request. At 514, the computing device 130 presents the retrieved set of information items to a user. A search interface of a search platform that presents the set of information items is described below with reference to FIG. 6A to FIG. 6D.

In this way, by using current information from the license server to update the license information base when the query request is received, a real-time search result can be provided, so that the user can easily learn about current license usage information.

FIGS. 6A-6D show schematic diagrams of search interfaces according to some embodiments of the present disclosure. FIG. 6A shows a schematic diagram of an initial search interface 601 after a search platform is started. As shown in FIG. 6A, the interface 601 includes four main tabs: Server, Feature, Expiration, and Usage. The interface 601 presents information items under the main tab Server. The information items include six categories: Server, Server status, Server version, License file address, Daemon, and Daemon version. In this embodiment, for example, since the current obtained information items are missing status information for the servers 1717@ic-lic01 and 1718@ic-lic01, their statuses are marked as a preset default item “UNKNOWN”, and information items related to them are presented in a manner different from other information items, that is, these information items are highlighted.

FIG. 6B shows a schematic diagram of a search interface 602 under the main tab Feature. As shown in FIG. 6B, there are three search boxes above the information for the user to enter a search keyword. In addition, each search box has a drop-down menu, and the user can also enter the search keyword by selecting an option in the drop-down menu. For example, “Expired” and “Unexpired” may be selected in the search box after “Present”. The content in the search box may be automatically filled in by the user clicking an information item under another tab. For example, the content in the “Server” search box may be filled in by the user clicking the server information item under the main tab Server.

FIG. 6C shows a schematic diagram of a search interface 603 under the main tab Expiration. As shown in FIG. 6C, the interface 603 presents unexpired software features whose daemon is Mgeld in the server 1057@ic-lic02. The last column of the interface 603 presents expiration dates of the software features. The information items in this column may be presented in different manners. For example, if a current date is more than 10 days away from an expiration date, the expiration date is presented on a white background; if the current date is less than 10 days and more than 3 days away from the expiration date, the expiration date is presented on a yellow background; if the current date is less than 3 days and more than 0 days away from the expiration date, the expiration date is presented on a gray background; and finally, if the current date is after the expiration date, the expiration date is presented on a red background.

FIG. 6D shows a schematic diagram of a search interface 604 under the main tab Usage. As shown in FIG. 6D, the interface 604 presents a search result whose server is 1017@ic-lic02, whose daemon is Mgcld, and whose execution device is N212-204. It can be seen that it has been at least more than 5 days since the user USER1 started Caldesignrev, which is not beneficial to license sharing. Therefore, a startup time that exceeds a startup time threshold by a lot is presented in a different color. In this way, by presenting an abnormal information item in a prominent display manner, it is easier to attract the attention of the user, so that the problem can be solved as soon as possible.

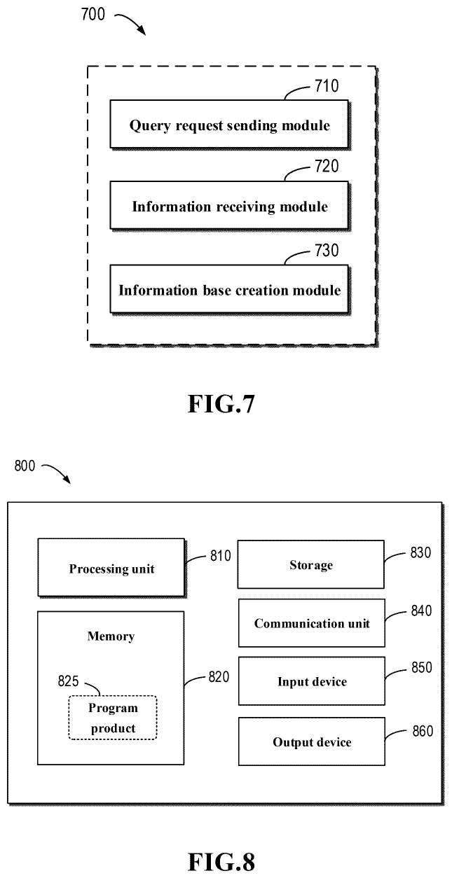

FIG. 7 shows a schematic block diagram of an example apparatus 700 according to some embodiments of the present disclosure. The apparatus 700 may be implemented through software, hardware, or a combination thereof.

As shown in FIG. 7, the apparatus 700 includes a query request sending module 710, configured to send a license query request to a license management module. The license query request is used for obtaining license information on one or more license servers. The apparatus 700 further includes an information receiving module 720, configured to receive the license information from the license management module. The license information is retrieved by the license management module from the one or more license servers. The apparatus 700 further includes an information base creation module 730, configured to create a license information base based on the received license information.

In some embodiments, the information base creation module 730 includes: an information item extraction unit, configured to extract at least one information item of at least one of the following categories for a plurality of EDA software features from the license information: a state of a license server, a state of a daemon, a total number of software features, an expiration of a software feature, a number of software features that are being used, a user who is using a software feature, and a usage time of a software feature that is being used; and create the license information base based on the at least one information item of the at least one category.

In some embodiments, the apparatus 700 further includes: a feature determining module, configured to determine, in response to receiving a query request for a first information item in the license information base, at least one EDA software feature associated with the first information item; an information item retrieval module, configured to retrieve a set of information items associated with the at least one EDA software feature from the license information base; and an information item presentation module, configured to present the set of information items.

In some embodiments, the information item retrieval module includes: a query request unit, configured to send another license query request to the license management module in response to receiving the query request for the first information item; a license information receiving unit, configured to receive second license information in response to the second license query request; an information updating unit, configured to update information in the license information base based on the second license information; and an information item retrieval unit, configured to retrieve the set of information items from the updated license information base.

In some embodiments, the information updating unit includes a preset value setting component, configured to set a value of a second information item in the license information base to a preset value in response to determining that the value of the second information item is missing from the second license information.

In some embodiments, the information item presentation module includes a first information item presentation unit, configured to present the second information item in a manner different from that of the first information item in response to determining that the value of the second information item is the preset value.

In some embodiments, the information item presentation module includes: a time comparison unit, configured to compare, in response to determining that a third information item of the set of information items includes an expiration of a software feature or a usage time of a software feature that is being used, the third information item with a corresponding time threshold; and a second information item presentation unit, configured to present the third information item in a manner associated with a comparison result based on the comparison result of the third information item and the corresponding time threshold.

In some embodiments, the information item extraction unit includes: a field determination component, configured to determine at least one field in the license information; a format determination component, configured to determine at least one format corresponding to the at least one category; a format selection component, configured to select, for each of the at least one field, a target format corresponding to the field from the at least one format; and an information item extraction component, configured to extract an information item from a corresponding position in the field based on the target format.

In some embodiments, the format selection component includes: a first format selection component, configured to select a first format from the at least one format; a first matching degree determination component, configured to determine a first matching degree between the first format and one field; and a first target format selection component, configured to select the first format as the target format in response to the first matching degree being greater than a predetermined matching degree threshold.

In some embodiments, the format selection component further includes: a second matching degree determination component, configured to determine, in response to the first matching degree being less than the predetermined matching degree threshold, a second matching degree between a second format in the plurality of formats and the one field; and a second target format selection component, configured to select the second format as the target format in response to the second matching degree being greater than the predetermined matching degree threshold.

In some embodiments, the first format selection component includes: a priority determination component, configured to determine a priority of a format corresponding to each category based on a ratio of a field of each category in the license information; and a priority format selection component, configured to select, from the at least one format, a format with a highest priority as the first format.

The apparatus 700 in FIG. 7 can be configured to implement the processes described above with reference to FIG. 2, FIG. 3, and/or FIG. 5. For the sake of brevity, details are not described herein again.

The division of the modules or units in the embodiments of the present disclosure is schematic and is merely a division of logical functions. There may be another division manner in actual implementation. In addition, functional units in the embodiments of the present disclosure may be integrated into one unit, may exist alone physically, or may be integrated into one unit by two or more units. The foregoing integrated unit may be implemented in a form of hardware, or may be implemented in a form of a software functional unit.

FIG. 8 shows a block diagram of an example device 800 that can be used to implement an embodiment of the present disclosure. It should be understood that the device 800 shown in FIG. 8 is merely exemplary, and shall not constitute any limitation on functions and a scope of implementations described herein. For example, the device 800 may be used to perform the processes described above with reference to FIG. 2, FIG. 3, and/or FIG. 5. For example, the device 800 may be implemented as a classic computer and/or a quantum computer.

As shown in FIG. 8, the device 800 is in the form of a general-purpose computing device. Components of the computing device 800 may include but are not limited to one or more processors or processing units 810, a memory 820, a storage device 830, one or more communication units 840, one or more input devices 850, and one or more output devices 860. The processing unit 810 may be an actual or virtual processor, and can execute various processing based on a program stored in the memory 820. In a multi-processor system, a plurality of processing units executes computer-executable instructions in parallel, to improve a parallel processing capability of the computing device 800.

The computing device 800 usually includes a plurality of computer storage media. Such media may be any available media accessible by the computing device 800, including but not limited to volatile and non-volatile media, and removable and non-removable media. The memory 820 may be a volatile memory (for example, a register, a cache, a random access memory (RAM)), a non-volatile memory (for example, a read-only memory (ROM), an electrically erasable programmable read-only memory (EEPROM), or a flash memory), or a combination thereof. The storage device 830 may be a removable or non-removable medium, and may include a machine-readable medium, such as a flash drive, a disk, or any other medium, which can be used to store information and/or data (for example, training data for training) and can be accessed in the computing device 800.

The computing device 800 may further include another removable/non-removable, volatile/non-volatile storage medium. Although not shown in FIG. 8, a disk drive for reading from or writing into a removable, non-volatile disk (for example, a “floppy disk”), and an optical disk drive for reading from or writing into a removable, non-volatile optical disk may be provided. In these cases, each drive may be connected to a bus (not shown) by one or more data medium interfaces. The memory 820 may include a computer program product 825, which has one or more program modules, and the program modules are configured to perform various methods or actions of various implementations of the present disclosure.

The communication unit 840 communicates with another computing device through a communication medium. In addition, functions of components of the computing device 800 may be implemented using a single computing cluster or a plurality of computing machines, and the computing machines can communicate through a communication connection. Therefore, the computing device 800 may operate in a networked environment by using a logical connection with one or more other servers, network personal computers (PCs), or another network node.

The input device 850 may be one or more input devices, for example, a mouse, a keyboard, or a trackball. The output device 860 may be one or more output devices, for example, a display, a speaker, or a printer. The computing device 800 may further communicate with one or more external devices (not shown) as required by using the communication unit 840, for example, a storage device, a display device, and the like, communicate with one or more devices that enable a user to interact with the computing device 800, or communicate with any device (for example, a network card, a modem, or the like) that enables the computing device 800 to communicate with one or more other computing devices. Such communication may be performed through an input/output (I/O) interface (not shown).

According to an example implementation of the present disclosure, a computer-readable storage medium is provided, wherein the computer-readable storage medium has a computer-executable instruction stored thereon, and the computer-executable instruction, when executed by a processor, causes the method described above to be implemented. According to an example implementation of the present disclosure, a computer program product is further provided, wherein the computer program product is physically stored in a non-transitory computer-readable medium and includes a computer-executable instruction, and the computer-executable instruction, when executed by a processor, causes the method described above to be implemented. According to an example implementation of the present disclosure, a computer program product is provided, wherein the computer program product has a computer program stored thereon, and the method described above is implemented when the program is executed by a processor.

Various aspects of the present disclosure are described here with reference to the flowcharts and/or block diagrams of the method, the apparatus, the device, and the computer program product implemented according to the present disclosure. It would be appreciated that each block of the flowchart and/or the block diagram and a combination of blocks in the flowchart and/or the block diagram may be implemented by computer-readable program instructions.

These computer-readable program instructions may be provided to a processing unit of a general-purpose computer, a special-purpose computer, or another programmable data processing apparatus, to produce a machine, such that the instructions, when executed by the processing unit of the computer or another programmable data processing apparatus, generate a device for implementing the functions/acts specified in one or more blocks in the flowchart and/or the block diagram. These computer-readable program instructions may alternatively be stored in a computer-readable storage medium. These instructions enable a computer, a programmable data processing apparatus, and/or another device to work in a specific manner. Therefore, the computer-readable medium storing the instructions includes a product manufactured, which includes instructions for implementing various aspects of the functions/acts specified in one or more blocks in the flowchart and/or the block diagram.

The computer-readable program instructions may be loaded onto a computer, another programmable data processing apparatus, or another device, so that a series of operation steps are performed on the computer, another programmable data processing apparatus, or another device, to generate a computer-implemented process. Therefore, the instructions executed on the computer, another programmable data processing apparatus, or another device implement the functions/acts specified in one or more blocks in the flowchart and/or the block diagram.

The flowcharts and the block diagrams in the accompanying drawings illustrate possibly implemented system architectures, functions, and operations of the system, the method, and the computer program product according to a plurality of implementations of the present disclosure. In this regard, each block in the flowchart or the block diagram may represent a part of a module, program segment, or instruction, and the part of the module, the program segment, or the instruction contains one or more executable instructions for implementing the specified logical functions. In some alternative implementations, the functions marked in the blocks may also occur in an order different from that marked in the accompanying drawings. For example, two blocks shown in succession may actually be performed substantially in parallel, or may sometimes be performed in the reverse order, depending on a function involved. It should also be noted that each block in the block diagram and/or the flowchart, and a combination of the blocks in the block diagram and/or the flowchart may be implemented by a dedicated hardware-based system that executes specified functions or acts, or may be implemented by a combination of dedicated hardware and computer instructions.

The foregoing describes various implementations of the present disclosure. The foregoing descriptions are exemplary, not exhaustive, and not limited to the disclosed implementations. Many modifications and changes are obvious to a person of ordinary skill in the art without departing from the scope and spirit of the described implementations. The selection of terms used in this specification is intended to best explain the principles, practical applications, or improvements to the technologies in the market of the implementations, or to enable a person of ordinary skill in the art to understand the implementations disclosed in this specification.

1. A method for creating a license information base, comprising:
sending a license query request to a license management module, the license query request being used for obtaining license information on at least one license server;
receiving the license information from the license management module, the license information being retrieved by the license management module from the at least one license server; and
creating a license information base based on the received license information.

2. The method according to claim 1, wherein creating the license information base comprises:
extracting at least one information item of at least one category of the following categories for a plurality of electronic design automation (EDA) software features from the license information: a state of a license server, a state of a daemon, a total number of software features, an expiration of a software feature, a number of software features that are being used, a user who is using a software feature, and a usage time of a software feature that is being used; and
creating the license information base based on the at least one information item of the at least one category.

3. The method according to claim 2, further comprising:
determining, in response to receiving a query request for a first information item in the license information base, at least one EDA software feature associated with the first information item;
retrieving a set of information items associated with the at least one EDA software feature from the license information base; and
presenting the set of information items.

4. The method according to claim 3, wherein retrieving the set of information items from the license information base comprises:
sending, in response to receiving the query request for the first information item, a second license query request to the license management module;
receiving second license information in response to the second license query request;
updating information in the license information base based on the second license information; and
retrieving the set of information items from the updated license information base.

5. The method according to claim 4, wherein updating the information in the license information base comprises:
setting, in response to determining that a value of a second information item in the license information base is missing from the second license information, the value of the second information item to a preset value.

6. The method according to claim 5, wherein presenting the set of information items comprises:
presenting, in response to determining that the value of the second information item is the preset value, the second information item in a manner different from that of the first information item.

7. The method according to claim 3, wherein presenting the set of information items comprises:
comparing, in response to determining that a third information item of the set of information items includes an expiration of a software feature or a usage time of a software feature that is being used, the third information item with a corresponding time threshold; and
presenting, based on a comparison result of the third information item and the corresponding time threshold, the third information item in a manner associated with the comparison result.

8. The method according to claim 1, further comprising:
determining at least one field in the license information;
determining at least one format corresponding to the at least one category;
selecting, for each of the at least one field, a target format corresponding to the field from the at least one format; and
extracting the information item from a corresponding position in the field based on the target format.

9. The method according to claim 8, wherein selecting the target format comprises:
selecting a first format from the at least one format;
determining a first matching degree between the first format and the one field; and
selecting, in response to the first matching degree being greater than a predetermined matching degree threshold, the first format as the target format.

10. The method according to claim 9, wherein selecting the target format further comprises:
determining, in response to the first matching degree being less than the predetermined matching degree threshold, a second matching degree between a second format of the plurality of formats and the one field; and
selecting, in response to the second matching degree being greater than the predetermined matching degree threshold, the second format as the target format.

11. The method according to claim 9, wherein selecting the first format comprises:
determining a priority of a format corresponding to each category based on a ratio of a field of each of the at least one category in the license information; and
selecting, from the at least one format, a format with a highest priority as the first format.

12. An electronic device, comprising:
at least one processing unit;
at least one memory, the at least one memory being coupled to the at least one processing unit and storing instructions executable by the at least one processing unit, wherein the instructions, when executed by the at least one processing unit, cause the electronic device to perform actions, the actions comprising:
sending a license query request to a license management module, the license query request being used for obtaining license information on at least one license server;
receiving the license information from the license management module, the license information being retrieved by the license management module from the at least one license server; and
creating a license information base based on the received license information.

13-14. (canceled)

15. A computer program product having a computer program stored on a non-transitory computer readable storage medium, wherein when the program is executed by a processor, the processor is caused to:
send a license query request to a license management module, the license query request being used for obtaining license information on at least one license server;
receive the license information from the license management module, the license information being retrieved by the license management module from the at least one license server; and
create a license information base based on the received license information.

16. The electronic device according to claim 12, wherein creating the license information base comprises:
extracting at least one information item of at least one category of the following categories for a plurality of electronic design automation (EDA) software features from the license information: a state of a license server, a state of a daemon, a total number of software features, an expiration of a software feature, a number of software features that are being used, a user who is using a software feature, and a usage time of a software feature that is being used; and
creating the license information base based on the at least one information item of the at least one category.

17. The electronic device according to claim 16, further comprising:
determining, in response to receiving a query request for a first information item in the license information base, at least one EDA software feature associated with the first information item;
retrieving a set of information items associated with the at least one EDA software feature from the license information base; and
presenting the set of information items.

18. The electronic device according to claim 17, wherein retrieving the set of information items from the license information base comprises:
sending, in response to receiving the query request for the first information item, a second license query request to the license management module;
receiving second license information in response to the second license query request;
updating information in the license information base based on the second license information; and
retrieving the set of information items from the updated license information base.

19. The electronic device according to claim 17, wherein updating the information in the license information base comprises:
setting, in response to determining that a value of a second information item in the license information base is missing from the second license information, the value of the second information item to a preset value.

20. The electronic device according to claim 19, wherein presenting the set of information items comprises:
presenting, in response to determining that the value of the second information item is the preset value, the second information item in a manner different from that of the first information item.

21. The electronic device according to claim 17, wherein presenting the set of information items comprises:
comparing, in response to determining that a third information item of the set of information items includes an expiration of a software feature or a usage time of a software feature that is being used, the third information item with a corresponding time threshold; and
presenting, based on a comparison result of the third information item and the corresponding time threshold, the third information item in a manner associated with the comparison result.

22. The electronic device according to claim 12, further comprising:
determining at least one field in the license information;
determining at least one format corresponding to the at least one category;
selecting, for each of the at least one field, a target format corresponding to the field from the at least one format; and
extracting the information item from a corresponding position in the field based on the target format.
